(19) United States
(12) Patent Application Publication
(10) Pub. No.: US 2008/0270653 A1
(43) Pub. Date: Oct. 30, 2008

(54) Intelligent resource management in multiprocessor computer systems

(76) Inventors: Susanne M. Balle, Hudson, NH (US); Richard Shaw Kaufmann, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,077

(22) Filed: Apr. 26, 2007

(51) Int. Cl. G06F 13/18

(52) U.S. Cl. 710/109

(57) ABSTRACT

In one embodiment, a computer system comprises at least a first processor core, at least one memory module coupled to the first processor core and the second processor core, the memory module comprising at least one application for execution by at least one of the first processor core, at least one resource manager to configure at least one component of the computer system according to at least one configuration parameter collected during a previous execution of the software application on the computer system.

### BACKGROUND

This application relates to computing and more particularly to intelligent resource management in multi-processor computer systems.

High performance computer systems may utilize multiple processors to increase processing power. Processing workloads may be divided and distributed among the processors, thereby reducing execution time and increasing performance. For example, some computer systems are now provided with processors that include multiple processing cores, each of which may be capable of executing multiple execution threads.

Similarly, single-core and/or multi-core computer systems may be combined into multiprocessor computer systems, which are often used in computer servers. One architectural model for high performance multiple processor computer system is the cache coherent Non-Uniform Memory Access (ccNUMA) model. Under the ccNUMA model, system resources such as processors and random access memory may be segmented into groups referred to as Locality Domains, also referred to as “nodes” or “cells”. Another architectural model for high performance multiple processor computer system is the distributed memory computing model where nodes are interconnected with each other by a high performance interconnect or by Ethernet. In both models, each node may comprise one or more processor cores and physical memory. A processor core in a node may access the memory in its node, referred to as local memory, as well as memory in other nodes, referred to as remote memory.

Multi-processor computer systems may be partitioned into a number of elements, also called cells or virtual machines. Each cell includes at least one, and more commonly a plurality, of processors. The various cells in a partitioned computer system may run different operating systems, if desired.

The performance of a specific application(s) executing on a multiprocessor computer system may be related to one or more configuration settings for resources managed by the computer system. Hence, techniques for the intelligent management of computer resources in multiprocessor systems may find utility.

### BRIEF DESCRIPTION OF THE DRAWINGS

FIGS. 1A, 1B and 1C are schematic illustrations of one embodiment of a multiprocessor computer system according to embodiments.

FIG. 2 is a block diagram of a cell, such as the cell depicted in FIG. 1B, according to some embodiments.

FIG. 3 is a flowchart illustrating operations in a method of operating a multiprocessor computer system according to some embodiments.

FIG. 4 is a schematic illustration of an embodiment of a data file to store configuration parameters and performance parameters.

### DETAILED DESCRIPTION

Described herein are exemplary systems and techniques for intelligent resource management in multi-processor computer systems. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

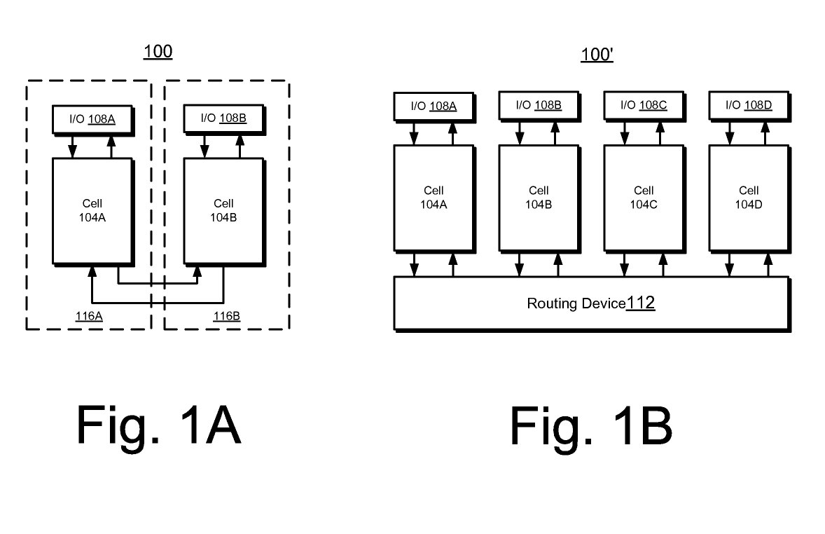

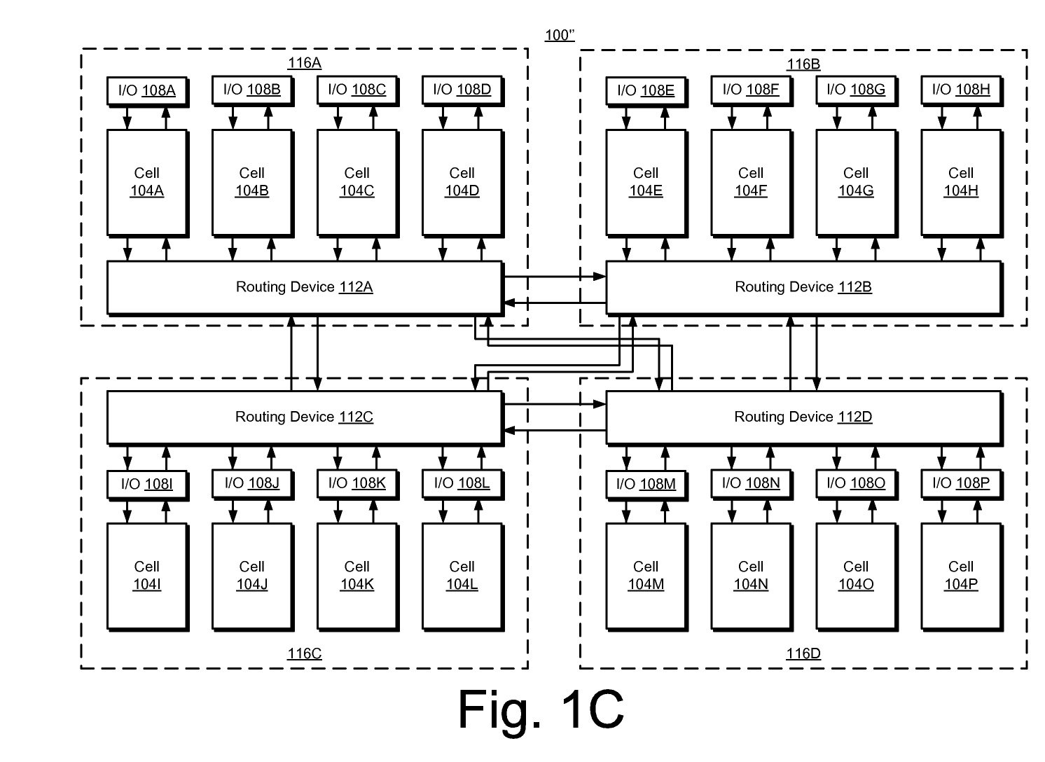

Intelligent resource management will be described herein with reference to multiprocessor computer systems. With reference to FIGS. 1A, 1B, and 1C, a multiprocessor computer system 100 can include a number of elements or cells 104. In FIG. 1A, only two cells 104A and 104B are present. However, more than two cells 104 can create the multiprocessor computer system 100. For example, FIG. 1B depicts a multiprocessor computer system 100′ having four cells 104A, 104B, 104C, and 104D. In FIG. 1C, sixteen cells 104A, 104B, 104C, 104D, 104E, . . . 104P, create the multiprocessor computer system 100″. Each cell 104 can communicate with a respective input and output module 108, which is used to provide input to the system 100 and output from the system 100.

In multiprocessor computer systems having more than two cells 104, for example systems 100′ and 100″ shown in FIGS. 1B and 1C, respectively, the cells 104 can communicate with each other through a routing device 112. The routing device can be a crossbar switch or other similar device that can route data packets. For example, a NUMAflex 8-Port Router Interconnect Module sold by SGI of Mountain View, Calif. can be used. The routing device 112 facilitates the transfer of packets from a source address to a destination address. For example, if cell 104A sends a packet to cell 104D, cell 104A sends the packet to the routing device 112, the routing device 112 in turn, transmits the packet to cell 104D.

In a larger multiprocessor computer system, such as the system 100″ shown in FIG. 1C, there can be more than one routing device 112. For example, there can be four routing devices 112A, 112B, 112C, and 112D. The routing devices 112 collectively can be referred to as the switch fabric. The routing devices 112 can communicate with each other and a number of cells 104. For example, cell 104A, cell 104B, cell 104C and cell 104D can communicate directly with routing device 112A. Cell 104E, cell 104F, cell 104G, and cell 104H can communicate directly with routing device 112B. Cell 104I, cell 104J, cell 104K, and cell 104L can communicate directly with routing device 112C. Cell 104M, cell 104N, cell 104O, and cell 104P can communicate directly with routing device 112D. In such a configuration, each routing device 112 and the cells 104 that the routing device 112 directly communicates with can be considered a partition 116. As shown, in FIG. 1C there are four partitions 116A, 116B, 116C and 116D. As shown, each partition includes four cells, however; any number of cells and combination of cells can be used to create a partition. For example, partitions 116A and 116B can be combined to form one partition having eight cells. In one embodiment, each cell 104 is a partition 116. As shown in FIG. 1A, cell 104 can be a partition 116A and cell 104B can be a partition 116B. Although the embodiment depicted in FIG. 1C has four cells, other embodiments may have more or fewer cells.

Each partition can be dedicated to perform a specific computing function. For example, partition 116A can be dedicated to providing web pages by functioning as a web server farm and partition 116B can be configured to provide diagnostic capabilities. In addition, a partition can be dedicated to maintaining a database. In one embodiment, a commercial data center can have three tiers of partitions, the access tier (e.g., a web farm), application tier (i.e., a tier that takes web requests and turns them into database queries and then responds to the web request) and a database tier that tracks various action and items.

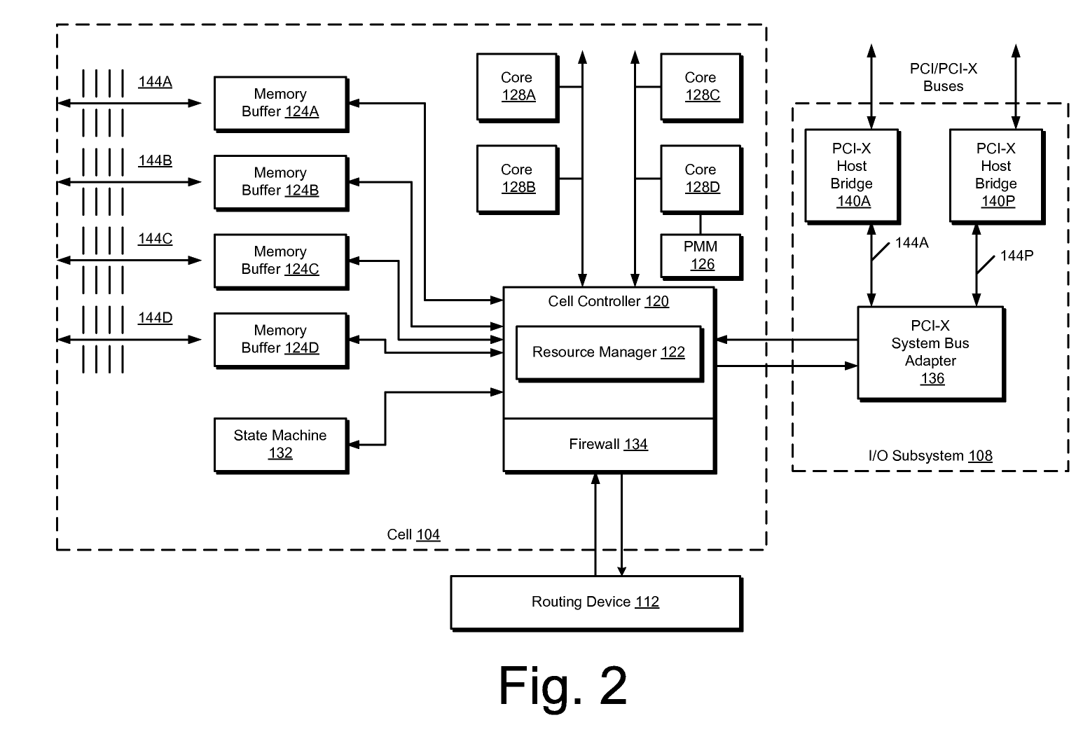

With reference to FIG. 2, each cell 104 includes a logic device 120, a plurality of memory buffers 124A, 124B, 124C, 124D (referred to generally as memory buffers 124), one or more processing cores 128A, 128B, 128C, 128D (referred to generally as cores 128), a state machine 132, and a firewall 134. The term core is not intended to be limited to a microprocessor, instead it is intended to be used to refer to any device that is capable of processing. The memory buffers 124, cores 128, and state machine 132 each communicate with the logic device 120. When the cell 104 is in communication with a crossbar 112, the logic device 120 is also in communication with the crossbar 112. The logic device 120 is also in communication with the I/O subsystem 108. The logic device 120 can be any kind of processor including, for example, a conventional processor, a field programmable gate array (FPGA) 132. The logic device 120 may also be referred to as the cell controller 120 through the specification. The logic device 120 includes a communications bus (not shown) that is used to route signals between the state machine 132, the cores 128, the memory buffers 124, the routing device 112 and the I/O subsystem 108. The cell controller 120 also performs logic operations such as mapping main memory requests into memory DIMM requests to access and return data and perform cache coherency functions for main memory requests so that the core and I/O caches are always consistent and never stale.

In one embodiment, the I/O subsystem 108 include a bus adapter 136 and a plurality of host bridges 140. The bus adapter 136 communicates with the host bridges 140 through a plurality of communication links 144. Each link 144 connects one host bridge 140 to the bus adapter 136. As an example, the bus adapter 136 can be a peripheral component interconnect (PCI) bus adapter. The I/O subsystem can include sixteen host bridges 140A, 140B, 140C, . . . , 140P and sixteen communication links 144A, 144B, 144C, . . . , 144P.

As shown, the cell 104 includes fours cores 128, however; each cell may include various numbers of cores 128. In one embodiment, the cores are ITANIUM based CPUs, which are manufactured by Intel of Santa Clara, Calif. Alternatively, SUN UltraSparc processors, IBM power processors, Intel Pentium processors, or other processors could be used. The memory buffers 124 communicate with eight synchronous dynamic random access memory (SDRAM) dual in line memory modules (DIMMS) 144, although other types of memory can be used.

Although shown as a specific configuration, a cell 104 is not limited to such a configuration. For example, the I/O subsystem 108 can be in communication with routing device 112. Similarly, the DIMM modules 144 can be in communication with the routing device 112. The configuration of the components of FIG. 2 is not intended to be limited in any way by the description provided.

In some embodiments, the computer system 100 includes a resource manager 122. The resource manager 122 may be embodied as logic instructions stored on a computer readable medium such as, e.g., one or more memory modules 144 associated with a cell. When executed, the logic instructions instantiate a resource manager 122 which operates on cell controller 120. In some embodiment a resource manager 122 may be instantiated on each cell controller. In alternate embodiments a single resource manager 122 may be instantiated on a cell controller or another processor in the computer system 100.

In some embodiments, resource manager 122 operates performs operations to implement intelligent resource management in computer system 100. For example, in some embodiments, resource manager 122 maintains one or more data tables in which historical execution data associated with applications that execute on computer system 100 is recorded. When an application is executed, resource manager 122 may consult the execution data stored in the data table and configure one or more components of the computer system 100 according to the configuration parameters in the data table.

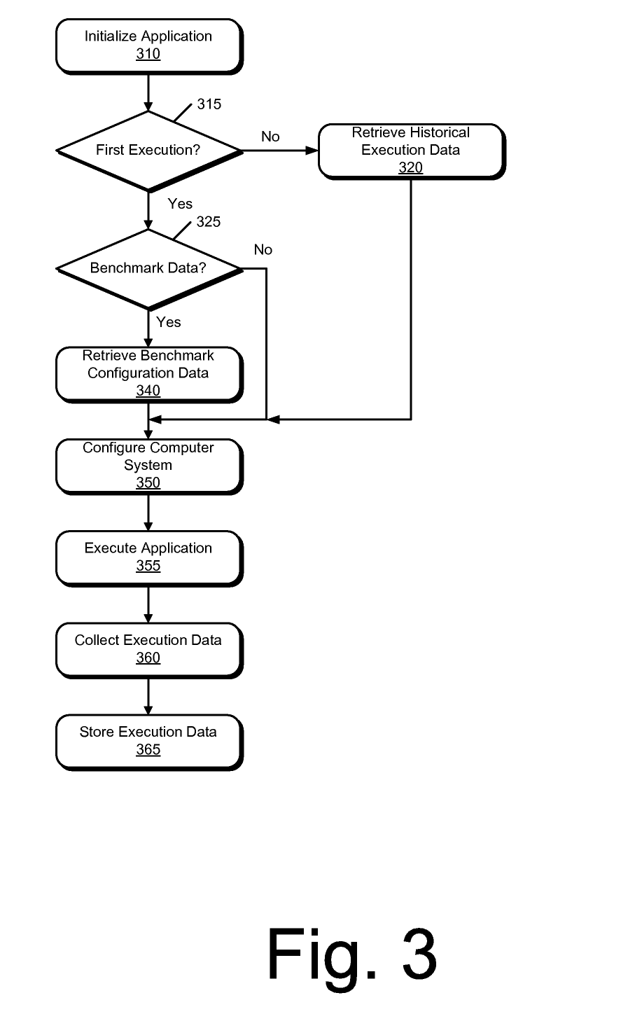

FIG. 3 is a flowchart illustrating operations in a method of operating a multiprocessor computer system according to some embodiments. Referring to FIG. 3, at operation 310 a software application is initialized for execution on computer system 100 or in the case of a parallel program simultaneously on several computer systems 100 tied together with a high performance interconnect or just Ethernet. The specific software application is not critical. For example, in a corporate context the software application may be an accounting software application on an inventory management software application.

At operation 315 it is determined whether the application has been executed previously on the computer system 100. If this is the first execution of the application on the computer system, then control passes to operation 325, where it is determined whether there is benchmark configuration data associated with the application. For example, in some embodiments developers of software applications may include benchmark configuration data for distribution with their application(s). The benchmark configuration data may specify, e.g., a recommended amount of computing resources (i.e., number of nodes, number of processor, socket, cores, threads, memory, application specific features such as numbering of the processes (block, cyclic, etc.), etc.) that should be dedicated to the application. Alternatively, the benchmark data may identify programs that have characteristics similar to the application being initialized.

If, at operation 325, benchmark data is available then control passes to operation 340 and the benchmark data for the application is retrieved. For example, the benchmark data may be retrieved from a memory location associated with the application. By contrast, if at operation 325 no benchmark data is available then control passes to operation 350 and the computer system platform is configured to execute the application. For example, the computer system may be configured to assign one or more specific processor cores to the application, or to assign specific input/output sockets to the application.

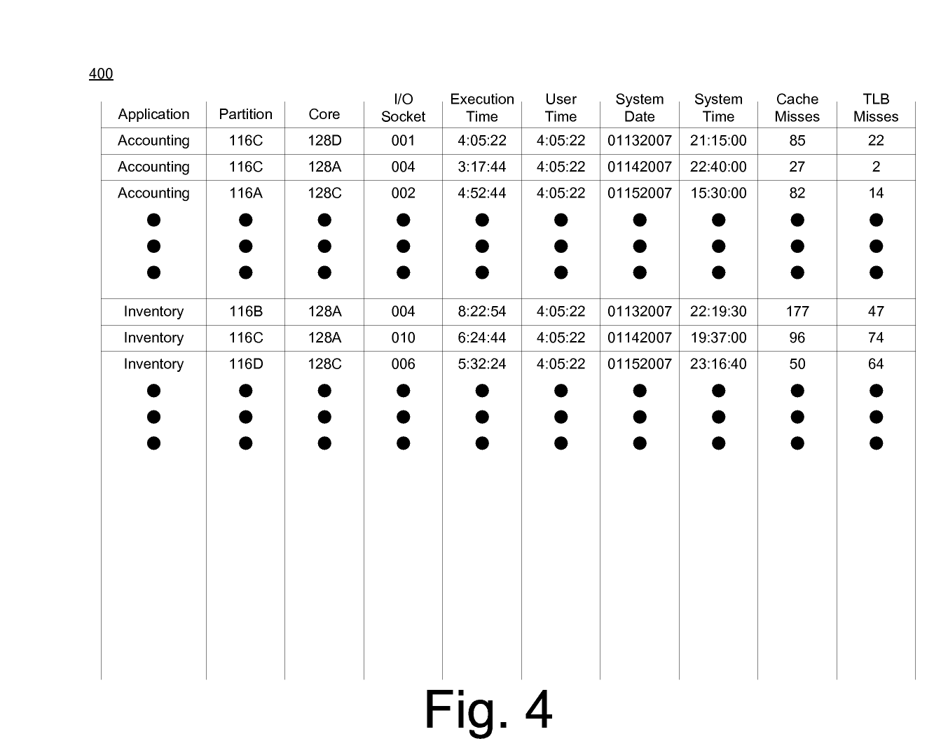

Referring back to operation 315, if the application has been executed previously, then control passes to operation 320 and historical execution data for the application is retrieved. In some embodiments the resource manager 122 maintains a data table of historical configuration data and execution data associated with the application. For example, FIG. 4 is a schematic illustration of an embodiment of a data file to store configuration parameters and performance parameters.

Referring to FIG. 4, a data file 400 may be organized as a data table that comprising entries (i.e., rows) that associate an application identifier with computer system configuration parameters and performance parameters for one or more previous executions of the application on the computer system. Thus, the embodiment depicted in FIG. 4 illustrates that an accounting application was executed on processor core 128D of petition 116C at 21:15:00 on Jan. 13, 2007 and was assigned to I/O socket 001. The application consumed execution time of 4:05:22 and incurred 85 cache misses and 22 translation lookaside buffer (TLB) misses. Additionally, the accounting application was executed on Jan. 14, 2007 and Jan. 15, 2007 at the times indicated in the table and with the configuration and performance statistics in the table. Similarly, an inventory program was executed on Jan. 13, 2007, Jan. 14, 2007 and Jan. 15, 2007 at the times indicated in the table and with the configuration and performance statistics in the table.

Other factors that my be incorporated into the table may include, for example, the number of execution cycles, flops, memory access patterns, interference between applications for one or more resources of the computer system, and the like.

Thus, at operation 320 historical configuration and performance data for the application may be retrieved from the data table 400. Control then passes to operation 350 and the resource manager 122 uses the historical execution data to configure the computer system 100 to execute the application. In some embodiments, the resource manager 122 may compare the various entries in the table 400 and may select a configuration that corresponds to the table entry that executed according to a performance threshold. For example, the resource manager may select a configuration that resulted in the fastest execution, or in the least number of cache misses, the least number of TLB misses or in some combination of these factors.

At operation 355 the application is executed on the computer system 100 or cluster of compute systems 100 using the configuration implemented in operation 350. During execution, at operation 360, the resource manager 122 collects execution data from the computer system 100 during execution of the application. For example, in some embodiments the resource manager 122 may collect information pertaining to the topology of the computer system 100, (i.e., the number of sockets, cores, shared caches, etc.), the number of cache misses, TLB misses, etc. In addition, the resource manager 122 may instantiate a number of application descriptor plug-ins that can guide the allocation of resources in the computer system.

At operation 365, data collected during execution of the application is stored in the data table 400. Thus, additional information may be added to the data table 400 with each execution of an application on the computer system 100.

Thus, the operations depicted in FIG. 3 and the data table depicted in FIG. 4 enable a computer system such as the systems depicted in FIGS. 1-2 to develop a knowledge base of configuration data and performance data for an application. The resource manager may use the knowledge base in FIG. 4 to configure the system or allocate resources to execute the application.

Embodiments described herein may be implemented as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least one implementation. The appearances of the phrase “in one embodiment” in various places in the specification are not necessarily all referring to the same embodiment.

What is claimed is:

1. A computer system, comprising:
at least a first processor core;
at least one memory module coupled to the first processor core, the memory module comprising at least one application for execution by at least one of the first processor or the second processor;
at least one resource manager to configure at least one component of the computer system according to at least one configuration parameter collected during a previous execution of the software application on the computer system.

2. The computer system of claim 1, wherein the resource manager is embodied as logic instructions stored on a computer readable medium coupled to the computer system.

3. The computer system of claim 1, wherein the resource manager:
collects at least one configuration parameter and at least one performance parameter during the execution of the software application; and
stores the at least one configuration parameter in a data file.

4. The computer system of claim 3, wherein the resource manager instantiates at least one performance measurement module in a node of the computer system.

5. The computer system of claim 1, wherein the performance measurement module monitors at least one of:
an execution time parameter for a portion of the software application;
a number of cache misses associated with the execution of the software application;
a memory access pattern.

6. The computer system of claim 1, wherein the resource manager stores at least one benchmark parameter associated with the application.

7. A method of operating a computer system comprising at least a first processor core, comprising:
initializing for execution at least one software application stored in a memory module coupled to at least one processor core;
configuring at least one component of the computer system according to at least one configuration parameter collected during a previous execution of the software application on the computer system.

8. The method of claim 7, wherein configuring at least one component of the computer system according to at least one configuration parameter collected during a previous execution of the software application on the computer system comprises retrieving, from historical execution data from a data file stored in a memory module coupled to the computer system.

9. The method of claim 7, further comprising
collecting at least one configuration parameter and at least one performance parameter during the execution of the software application; and
storing the at least one configuration parameter in a data file.

10. The method of claim 9, further comprising instantiating at least one performance measurement module in a node of the computer system.

11. The method of claim 7, wherein the performance measurement module monitors at least one of:
an execution time parameter for a portion of the software application;
a number of cache misses associated with the execution of the software application;
a memory access pattern.

12. The method of claim 7, further comprising storing at least one benchmark parameter associated with the application.

13. A computer program product comprising logic instructions stored on a computer readable medium which, when executed by a processor, configure the processor to:
initialize for execution at least one software application stored in a memory module coupled to at least one processor core;
configuring at least one component of the computer system according to at least one configuration parameter collected during a previous execution of the software application on the computer system.

14. The computer program product of claim 13, wherein configuring at least one component of the computer system according to at least one configuration parameter collected during a previous execution of the software application on the computer system comprises retrieving, from historical execution data from a data file stored in a memory module coupled to the computer system.

15. The method of claim 13, further comprising
collecting at least one configuration parameter and at least one performance parameter during the execution of the software application; and
storing the at least one configuration parameter in a data file.

16. The method of claim 13, further comprising instantiating at least one performance measurement module in a node of the computer system.

17. The method of claim 16, wherein the performance measurement module monitors at least one of:
an execution time parameter for a portion of the software application;
a number of cache misses associated with the execution of the software application;
a memory access pattern.

18. The method of claim 13, further comprising storing at least one benchmark parameter associated with the application.
